(19) United States
(12) Patent Application Publication
(10) Pub. No.: US 2008/0021640 A1
(43) Pub. Date: Jan. 24, 2008

(54) APPARATUS AND METHOD FOR PROVIDING PERSONALIZED ROUTE GUIDANCE USING A NAVIGATION GAME

(75) Inventor: Jong-Sun PYO, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/779,111

(22) Filed: Jul. 17, 2007

(30) Foreign Application Priority Data
Jul. 20, 2006 (KR) 68215-2006

(51) Int. Cl. G01C 21/34

(52) U.S. Cl. 701/209

(57) ABSTRACT

An apparatus and method for providing personalized route guidance using a navigation game are provided. A user can learn in advance the route for a destination through the navigation game in a terminal with a navigation function. Driving habit data for the user is stored in a database through the navigation game. The personalized route guidance can be provided in which the driving habit data for the user is reflected in the navigation function at the time of actual driving.

### PRIORITY

This application claims priority under 35 U.S.C. § 119(a) to a Korean Patent Application filed in the Korean Intellectual Property Office on Jul. 20, 2006, and assigned Serial No. 2006-68215, the entire disclosure of which is incorporated by reference.

### BACKGROUND OF THE INVENTION

1. Field of the Invention

The present invention generally relates to a terminal with a navigation function. The present invention relates more particularly to an apparatus and method in which a route for a destination is learned in advance using a navigation game in a terminal with a navigation function.

2. Description of the Related Art

In general, a terminal with a navigation function indicates its current location in three-dimensional coordinates using the Global Positioning System (GPS). The terminal with the navigation function provides a user with various pieces of information required for driving, such as the moving direction, the distance to a target destination, the current moving speed of a moving object, the route set by a driver before driving, the optimum route for the destination, and the like. Various moving objects such as ships, airplanes, vehicles, and the like widely use GPS terminals to check their current location and moving speed or determine a route. The GPS terminal visually displays or audibly outputs map information, including the current location, after receiving radio waves indicating latitude, longitude, and altitude from three artificial satellites and computing the current location of a moving object. The GPS includes an embedded automatic navigation map for a terminal mounted in a moving object, and determines the location of a moving object on a road using a scheme of map matching between an electronic map stored in the terminal and three-dimensional coordinates obtained by computing the current location using a gyro sensor, an acceleration sensor, and the like.

The terminal with the navigation function is mounted in a vehicle and is used for navigation that provides a driver with the route for a desired destination.

Since the terminal equipped with the navigation function only provides guidance such that the driver drives to the desired destination, the user may not know in advance a route calculation result, an overall road state, and the like. For this reason, there is a problem in that a novice driver or a driver who drives on a road he is unaccustomed to may be confused when missing an image or voice provided from the terminal due to an unexpected road or traffic situation while driving. Since driving guidance is provided independent of a user's driving pattern, when driving guidance is provided through the navigation function, it is difficult for a user unfamiliar with driving to immediately take action. For example, when left turn guidance is provided at 50 meters before turning left, a user familiar with the associated location or road may make the left turn according to guidance. However, a user with little driving experience or a user who drives on an unaccustomed road may not make the left turn due to unfamiliarity with the vehicle or the road.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for providing personalized route guidance in which the route for a user's destination can be learned in advance through a navigation game in a terminal with a navigation function.

Another aspect of exemplary embodiments of the present invention is to provide an apparatus and method that can provide personalized route guidance on the basis of a user's driving pattern when driving guidance is provided in a terminal with a navigation function.

A further aspect of exemplary embodiments of the present invention is to provide an apparatus and method for providing personalized route guidance that can provide a route reflecting a user's real-time driving pattern after the user's driving pattern is stored in a database through a navigation game.

In accordance with an aspect of exemplary embodiments of the present invention, there is provided an apparatus for providing personalized route guidance using a navigation game, including a key input unit for outputting a key signal mapped to a key input; a memory for storing the driving pattern learning table used for storing a score associated with an item corresponding to a user's action in a traffic situation, the driving pattern learning table having at least one item associated with the traffic situation which occurred while the navigation game is executed; a controller for determining whether to reflect an actual traffic situation when entering navigation game mode and departure and destination information are input to the game, receiving real-time traffic information when selection for reflecting real-time traffic information is made, and outputting an image in which the received traffic information is reflected in an electronic map for the navigation game; and a display for displaying the image output from the controller.

In accordance with another aspect of exemplary embodiments of the present invention, there is provided a method for providing personalized route guidance using a navigation game, including determining whether to reflect an actual traffic situation when entering navigation game mode and departure and destination information are input to the game; and receiving real-time traffic information when selection for reflecting the actual traffic situation is made and displaying an image in which the received traffic situation information is reflected in an electronic map for the navigation game.

### BRIEF DESCRIPTION OF THE DRAWINGS

The above and other features and advantages of the present invention will be more apparent from the following detailed description taken in conjunction with the accompanying drawings, in which:

FIG. 1 is a block diagram of a terminal with a navigation function in accordance with the present invention;

FIG. 2 is a control flowchart of a process for implementing a navigation game function in a terminal and storing a user's driving pattern in a database during a game in accordance with the present invention;

FIG. 3 is a control flowchart of a process for performing an actual navigation function in accordance with the present invention; and

FIG. 4A-4D illustrate navigation game images in accordance with the present invention.

### DETAILED DESCRIPTION OF PREFERRED EMBODIMENTS

Exemplary embodiments of the present invention will be described in detail herein below with reference to the accompanying drawings. In the drawings, the same or similar elements are denoted by the same reference numerals even though they are depicted in different drawings. Descriptions of well-known functions and constructions are omitted for clarity and conciseness.

The present invention provides a scheme that can prevent an accident by implementing a navigation game function in a terminal with a navigation function. Using a navigation game, a user can learn in advance geographic features, roads, geographic names and traffic information to reach a desired destination. Moreover, the present invention provides a scheme that can exploit intelligent personalized navigation for a user when using actual navigation by storing, in a database, the user's driving pattern evaluated while the navigation game is being executed.

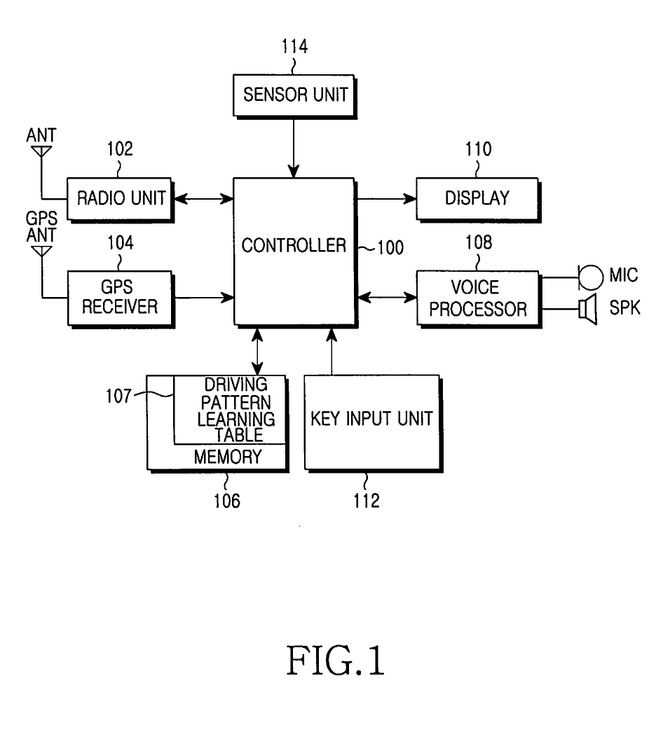

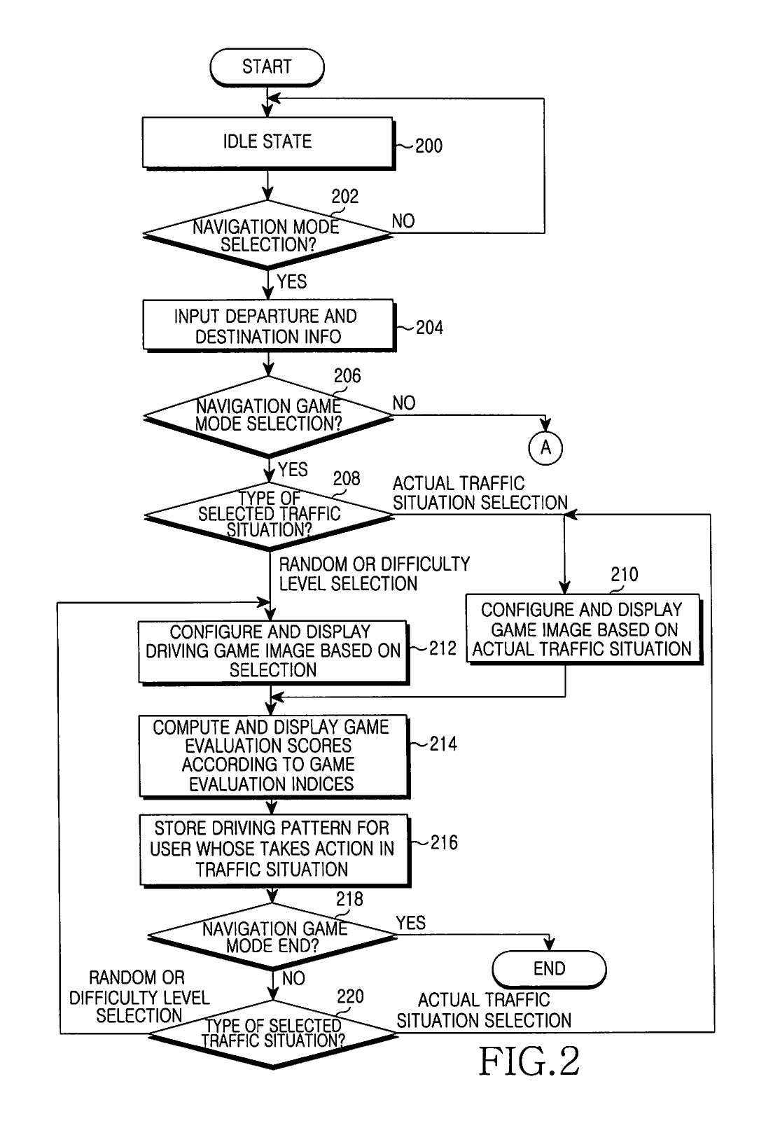

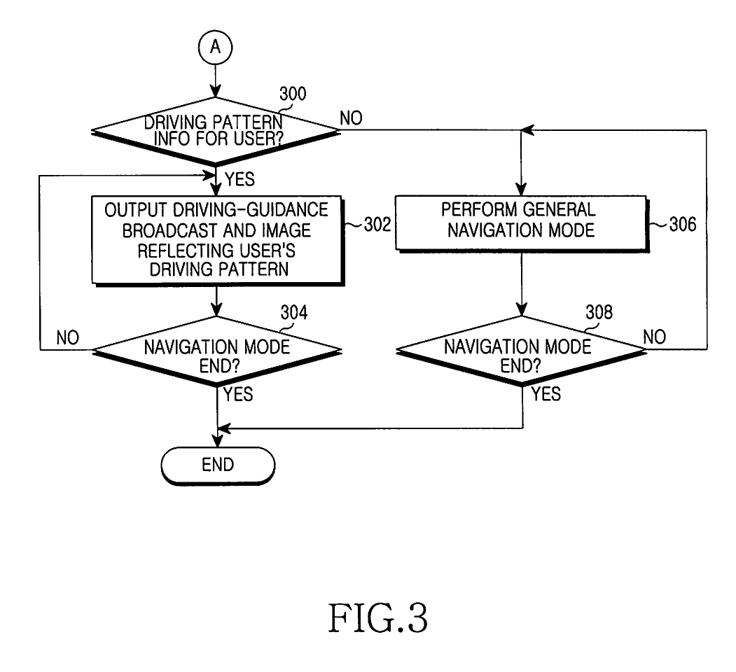

Now, an internal structure of the terminal for providing real-time driving guidance by performing the navigation game function and applying the user's driving pattern stored in the database through the navigation game will be described with reference to FIG. 1. FIG. 1 is a block diagram of the terminal with the navigation function in accordance with the present invention. A controller 100 controls the overall operation of the terminal, and also controls the operation for providing driving guidance to which the user's driving pattern is applied at the time of actual driving after the navigation game is executed. The user's driving pattern is stored in the database during the navigation game in accordance with the present invention. The control operation of controller 100 will be described in detail with reference to the control flowcharts of FIGS. 2 and 3.

A radio unit 102 transmits a radio signal to and receives a radio signal from a mobile communication base station via an antenna. Radio unit 102 modulates a transmission signal input from controller 100 and then transmits a radio frequency (RF) signal via the antenna. Radio unit 102 demodulates an RF signal received via the antenna and then outputs the demodulated signal to controller 100. In particular, in an exemplary embodiment of the present invention, radio unit 102 transmits departure/destination information input by the user to a route calculation server (not illustrated) via a wireless network. When the route calculation server transmits optimum route data by computing a route from the departure to the destination using real-time traffic information, pre-stored map data, and the like, radio unit 102 receives the optimum route data and outputs the received data to controller 100. At this time, the optimum route data includes, for example, a link number, a route distance, and a road type as driving information of a link unit.

A Global Positioning System (GPS) receiver 104 communicates with a positioning satellite to track the location of the terminal and outputs three-dimensional coordinates representing the location of the user to controller 100.

A memory 106 stores a program for processing and controlling operations of controller 100, reference data, various application programs for processing multimedia files, and various repository data, such as an electronic map and the like. Memory 106 also serves as the working memory of controller 100. In particular, in an exemplary embodiment of the present invention, memory 106 stores a driving pattern learning table 107, which stores the driving pattern information of the user. Driving pattern learning table 107 includes an item indicating whether accurate driving is made in the course of a calculated route, an item indicating whether traffic safety signs are obeyed, an item indicating how much the estimated time is reduced through proper action where a change such as a traffic jam is encountered in an intersection or road, an item indicating whether real-time traffic information or user input traffic information is understood and moving time is minimized, and an item indicating whether action is proper in case of a collision accident in a zone where accidents frequently occur and an unexpected situation in a child safety zone. Memory 106 stores evaluations and scores of the items when a vehicle is driven in response to the user's input during navigation game mode. For example, if accurate driving is maintained in the course of the calculated route, a score of +1 is computed for the associated item. If accurate driving is not maintained in the course of the calculated route, a score of −1 is computed. If posted traffic safety signs are obeyed, the score of +1 is computed. If posted traffic safety signs are not obeyed, the score of −1 is computed. If criteria set on an item-by-item basis are met, the score of +1 is assigned. Otherwise, the score of −1 is assigned. The scores can be stored on the item-by-item basis. When an event occurs in which the user changes the vehicle's direction or reduces vehicle's speed due to a left turn, a right turn, and camera detection, the score is computed such that the user's driving pattern is stored. The score related to the event can be used to determine the time at which the event occurrence is reported in advance of the user actually driving. For example, an event such as a left or right turn vehicle direction change can be reported at 50 meters before the event's occurrence when navigation is output. When the user does not continuously change the vehicle's direction, the score for the associated item is less than a predefined score. In this case, new setting can be made such that the event can be reported at 100 meters before the event's occurrence. Thus, the event can be reported at 100 meters before the event's occurrence when actual driving is undertaken.

A voice processor 108 processes a voice signal input to or a voice signal output from a mobile communication terminal for recording or outputting voice.

Under control of controller 100, a display 110 displays various received information or data stored in memory 106 on a screen.

A key input unit 112 is provided with number keys of 0˜9, * and # keys, and a plurality of function keys mapped to functions of Menu, Select, Call, Delete, Power/End, Volume Control, and the like provided in the associated mobile communication terminal. Key input unit 112 outputs key input data mapped to a key pressed by the user to controller 100.

A sensor unit 114 includes Dead Reckoning (DR) sensors such as GPS, gyro, acceleration and geomagnetic sensors and the like. Sensor unit 114 receives a user input through the gyro, acceleration or geomagnetic sensor. Sensor unit 114 is provided with sensors for outputting signals related to collisions with vehicles and objects and vibrations using sensors of a vibration motor and the like during a vehicle driving game. Real-time information regarding the road slope, moving direction, moving speed, and the like detected by sensor unit 114 is provided to controller 100.

Next, the navigation game in the terminal with the navigation function as illustrated in FIG. 1 and performance of the navigation function using the user's real-time driving pattern by storing the user's driving pattern in the database during the navigation game will be described with reference to FIGS. 2 and 3.

Implementing the navigation game function and storing the user's driving pattern in the database during the game in the terminal with the navigation function in accordance with an exemplary embodiment of the present invention will be described with reference to FIG. 2.

Controller 100 is in an idle state in step 200 and determines in step 202 if navigation mode is selected through the key input unit 112. If the navigation mode is selected, the controller proceeds to step 204 to output an image for receiving departure and destination information from the user and transmit the departure and destination information entered by the user to route calculation server through the radio unit 102. When the route calculation server computes and transmits data of an optimum route from the departure point to the destination point using real-time traffic information received from an information center and pre-stored map data, radio unit 102 receives the optimum route data and outputs the received route data to controller 100.

Controller 100 determines if the navigation game mode is selected in step 206. If the navigation game mode is selected, controller proceeds to step 208. Otherwise, the controller proceeds to “A”. The case where the controller proceeds to “A” will be described with reference to FIG. 3.

On the other hand, when the navigation game mode is selected, controller 100 receives selection information regarding a traffic situation. The selection information range from Random, to Difficulty Level or Actual Traffic Situation selected by the user in step 208. The traffic situation can be an unexpected situation in which a neighboring vehicle cuts in line or a vehicle, bicycle, motorcycle or person abruptly appears while the navigation game is being executed.

The controller proceeds to step 210 or 212 depending on the user's selection in step 208.

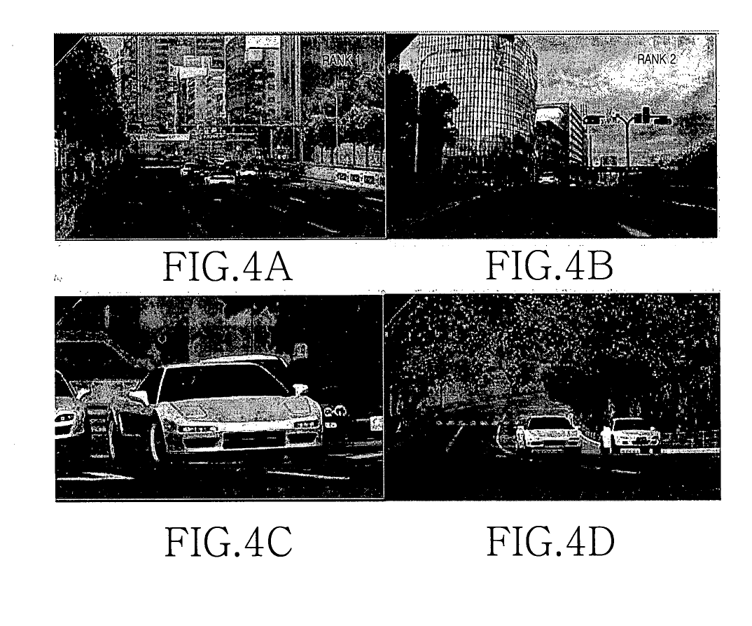

When Random or Difficulty Level is selected, controller 100 configures a driving game image according to selection and controls display 110 to display the configured image in step 212. That is, when Random is selected, controller 100 randomly configures a driving game image without a specific rule in the traffic situation. When a specific difficulty level is selected, controller 100 configures a driving game image at the selected difficulty level and then controls display 110 to display the configured image. The configured driving game images can be displayed such that the game can be executed using actual map data of roads, buildings, geographic names, and the like, as illustrated in FIG. 4.

On the other hand, when Actual Traffic Situation is selected, controller 100 configures a game image in response to received traffic situation information after receiving the traffic situation information from a server for providing the traffic situation information via an Internet network, and then controls display 110 to display the configured image in step 210. The traffic information can be received via the Internet and can be received through the Transportation Protocol Experts Group (TPEG) using a Digital Multimedia Broadcasting (DMB) network. If the traffic information is received through TPEG, a DMB receiver should be included in the terminal of FIG. 1.

After steps 210 and 212 are performed, controller 100 computes game evaluation scores according to game evaluation indices and controls display 110 to display the computed scores in step 214. Then, controller 100 stores the evaluation scores computed in step 214 mapped to items stored in the driving pattern learning table 107 in step 216. Next, controller 100 generates driving pattern information for the user on the basis of item-by-item scores. Herein, the game evaluation indices indicate the items stored in driving pattern learning table 107. For example, there are five game evaluation indices. The scores evaluated according to evaluation indices during the game are stored in the items of driving pattern learning table 107. Next, the five game evaluation indices will be described.

First, a score is computed by evaluating whether accurate driving is maintained in the course of a calculated route. The computed score is stored in an associated item of driving pattern learning table 107. That is, the score is computed by evaluating how accurately the driving operation is made on the basis of lanes, courses and traffic signals in the route configured by the departure and destination information set by the user. The computed score is stored in the associated item of driving pattern learning table 107.

Second, a score is computed by evaluating how much the estimated time is reduced through proper action where a change such as a traffic jam is encountered at an intersection or road. The computed score is stored in an associated item of driving pattern learning table 107. That is, actual traffic information received via the Internet network or TPEG or traffic information entered by the user and traffic jam information is reflected in the calculated route in the vehicle driving game. The score is computed by evaluating how much the moving time is reduced through proper action of the user and is stored in the associated item of driving pattern learning table 107.

Third, a score is computed by evaluating whether posted traffic safety signs are obeyed. The computed score is stored in an associated item of driving pattern learning table 107. That is, the score is computed by evaluating whether actual section-by-section traffic safety signs and traffic safety signs of stop lines and the like are obeyed. The computed score is stored in the associated item of driving pattern learning table 107.

Fourth, a score is computed by evaluating whether actual traffic information or user input traffic information is understood or not, and whether moving time is minimized. The computed score is stored in an associated item of driving pattern learning table 107. That is, when an accident and therefore a congestion area occur in an intersection, they are reflected in the vehicle driving game. The score is computed by evaluating whether the left/right turn is actively selected for lane selection, and whether fast and safe route selection took place. The score is computed through evaluation based on reduction of the necessary time and the congestion time in an estimated route. The computed score is stored in the associated item of driving pattern learning table 107.

Fifth, a score is computed by evaluating whether action is proper in case of a collision in a zone where accidents frequently occur and an unexpected situation in a child safety zone. The computed score is stored in an associated item of driving pattern learning table 107. That is, information regarding a zone where accidents frequently occur due to inadequate road design and a zone where pedestrian accidents frequently occur is reflected in the vehicle driving game. The score is computed by evaluating the damage of the collision and human accident is reduced when a vehicle, pedestrian, child, or elderly person abruptly appears. The computed score is stored in the associated item of driving pattern learning table 107.

On the other hand, when the controller proceeds from step 216 to step 218, controller 100 determines if a key is input to end the navigation game mode. If so, the game mode ends. Otherwise, the process proceeds to step 220 to determine whether a selected traffic situation applied to the navigation game mode is Actual Traffic Situation, Random or Difficulty Level. When Actual Traffic Situation is selected, the controller proceeds to step 210. When Random or Difficulty Level is selected, the controller proceeds to step 212 to continuously perform the navigation game mode.

An example in which one user executes the navigation game using its own terminal in the exemplary embodiment of the present invention as illustrated in FIG. 2 has been described. Multiple users can execute a driving competition game in which ranks are set by computing scores according to the five game evaluation indices in the same electronic map using local area network communication such as Bluetooth® communication.

A process for proceeding to “A” upon determining that the navigation mode is selected without selecting the navigation game mode in step 206 will be described with reference to FIG. 3.

In step 300, controller 100 determines whether there is driving pattern information for the user. That is, controller 100 determines whether the user's driving pattern is stored in the database after the navigation game mode is performed. When the driving pattern information for the user is present, the process proceeds to step 302 to reflect the user's driving pattern and output a driving-guidance broadcast and image. However, upon determining that the driving pattern information for the user is absent in step 300, general navigation mode is performed.

On the other hand, it is determined whether a key is input to end the navigation mode in steps 304 and 308. When the end key is inputted, the navigation mode ends. Otherwise, the process loops back from step 304 to step 302 and loops back from step 308 to step 306 in order to continuously perform the navigation mode.

In the present invention as described above, a driving operation can be learned in advance using a game in a terminal with a navigation function. Thus a user who drives on a road unfamiliar to him or her or a novice driver can learn the road state for a destination through the game. When the game is executed, the user's driving pattern is stored in a database. When the navigation function for actual driving is performed, personalized route guidance can be provided.

Although exemplary embodiments of the present invention have been disclosed for illustrative purposes, those skilled in the art will appreciate that various modifications, additions, and substitutions are possible, without departing from the scope of the present invention. An example of the driving game mode has been described in the exemplary embodiment of the present invention. Alternatively, the present invention can be applied to a guidance game for a pedestrian or traveler who goes to a tourist attraction or travels on a road unfamiliar to him or her.

While preferred embodiments of the present invention have been shown and described in this specification, it will be understood by those skilled in the art that various changes or modifications of the embodiments are possible without departing from the spirit and scope of the invention as further defined by the appended claims.

What is claimed is:

1. An apparatus for providing personalized route guidance using a navigation game, comprising:
a key input unit for outputting a key signal mapped to a key input;
a display for displaying input date;
a memory for storing a driving pattern learning table, and for storing a score in an associated item according to a user's action in a traffic situation, the driving pattern learning table having at least one item of the traffic situation occurring while the navigation game is being executed;
a controller for determining whether to reflect an actual traffic situation when a navigation game mode is selected, and departure and destination information are input for the game; and
receiving traffic information when selection for reflecting the actual traffic situation is made, and displaying an image in which the received traffic information is reflected in an electronic map for the navigation game through the display.

2. The apparatus of claim 1, further comprising:
a Digital Multimedia Broadcasting (DMB) receiver for receiving the traffic information through the Transportation Protocol Experts Group (TPEG),
wherein the controller controls the DMB receiver to receive the traffic information when the selection for reflecting the actual traffic situation is made and outputs the image in which the received traffic situation information is reflected in the electronic map for the navigation game.

3. The apparatus of claim 1, further comprising:
a radio unit for receiving the traffic information from a server that provides the traffic information through an Internet network,
wherein the controller receives the traffic information through the radio unit when the selection for reflecting the actual traffic situation is made and outputs the image in which the received traffic information is reflected in the electronic map for the navigation game.

4. The apparatus of claim 1, wherein the at least one item of the traffic situation comprises:
an item indicating whether accurate driving is maintained in the course of a calculated route;
an item indicating how much the estimated time is reduced through proper action where a change such as a traffic jam occurs in at least one of an intersection and a road;
an item indicating whether traffic safety signs are obeyed;
an item indicating whether at least one of actual traffic information and user input traffic information is understood and a moving time is minimized; and
an item indicating whether action is proper in case a collision occurs in a zone where accidents frequently occur and an unexpected situation in a child safety zone.

5. The apparatus of claim 1, wherein the controller computes the score according to the user's action in the traffic situation occurring while the navigation game is being executed, stores the computed score in the associated item of the driving pattern learning table, and generates driving pattern information for the user on a basis of the score of the associated item.

6. The apparatus of claim 5, wherein the controller determines whether the driving pattern information for the user is present when navigation mode for actual driving is selected and outputs a driving-guidance broadcast and image in which the driving pattern information for the user is reflected if the driving pattern information for the user is present.

7. The apparatus of claim 6, wherein the controller outputs a driving-guidance broadcast and image in general navigation mode if the driving pattern information for the user is absent.

8. A method for providing personalized route guidance using a navigation game, comprising:
determining whether to reflect an actual traffic situation when the navigation game mode is selected and departure and destination information are input for the game; and
receiving traffic situation information when selection for reflecting the actual traffic situation is made, and displaying an image in which the received traffic information is reflected in an electronic map for the navigation game.

9. The method of claim 8, further comprising:
providing a driving pattern learning table for storing a score in an associated item according to user's action in an occurred traffic situation, the driving pattern learning table having at least one item of the traffic situation occurring while the navigation game is executed.

10. The method of claim 9, wherein the at least one item of the traffic situation comprises:
an item indicating whether accurate driving is made in the course of a calculated route;
an item indicating how much the estimated time is reduced through proper action where a change such as a traffic jam occurs in at least one of an intersection and a road;
an item indicating whether traffic safety signs are obeyed;
an item indicating whether at least one of actual traffic information and user input traffic information is understood and a moving time is minimized; and
an item indicating whether action is proper in case a collision occurs in a zone where accidents frequently occur and an unexpected situation in a child safety zone.

11. The method of claim 9, further comprising:
computing the score according to the user action in the traffic situation occurring while the navigation game is being executed; and
storing the computed score in the associated item of the driving pattern learning table and generating driving pattern information for the user on a basis of the score of the associated item.

12. The method of claim 11, further comprising:
determining whether the driving pattern information for the user is present when navigation mode for actual driving is selected; and
outputting a driving-guidance broadcast and image in which the driving pattern information for the user is reflected if the user driving pattern information is present.

13. The method of claim 12, further comprising:
outputting a driving-guidance broadcast and image in general navigation mode if the driving pattern information for the user is absent.
